(19) United States
(12) Patent Application Publication
(10) Pub. No.: US 2018/0161878 A1
(43) Pub. Date: Jun. 14, 2018

(54) METHOD FOR MANUFACTURING A COMPOSITE MATERIAL WITH METAL MATRIX AND CARBON REINFORCEMENT

(71) Applicant: Nexans, Paris (FR)

(72) Inventor: Francis Debladis, Saint Catherine Les Arras (FR)

(21) Appl. No.: 15/104,662

(22) PCT Filed: Dec. 2, 2014
(86) PCT No.: PCT/FR2014/053112

§ 371 Date: Jun. 15, 2016

(30) Foreign Application Priority Data
Dec. 18, 2013 (FR) 13 62898

(51) Int. Cl. B22F 3/20; H01B 1/02; H01B 1/04

(52) U.S. Cl. CPC B22F 3/20; H01B 1/023; C22C 2026/002; H01B 1/04; H01B 1/026

(57) ABSTRACT

The invention relates to a method for manufacturing a composite material (8) comprising a metal matrix reinforced by a carbon reinforcement, characterised in that the method is a continuous extrusion method which comprises friction-heating of a mixture (7) obtained from a mixture of powders comprising a metal-matrix powder and a carbon-reinforcement powder, by means of a movable extrusion wheel (2), in a passage formed between a groove (2a) of the wheel (2) and a stationary element referred to as shoe (3), followed by carrying the mixture (7) thus heated towards an extrusion die (4).

The subject of the present invention is a process for manufacturing a composite material comprising a metal matrix reinforced by a carbon reinforcement, and in particular by carbon nanotubes. The process is particularly suitable for the manufacture of electrical conductors for cables and of metal reinforcing elements.

A composite material consists of several elementary components, the combination of which imparts a set of properties that none of the components, taken separately, possesses. The objective that is usually desired by substituting a composite material for a conventional material is, for the same structural rigidity, a sizeable mass gain. A composite material consists of two phases:
the matrix, and
the reinforcement or the filler.

Composites with micrometer-sized reinforcements have demonstrated some of their limits. Their properties result from a compromise: the improvement in the strength, for example, takes place to the detriment of the plasticity or of the optical transparency. Nanocomposites may overcome some of these limits and exhibit advantages compared to conventional composites with micrometer-sized reinforcements:
a significant improvement in mechanical properties, in particular strength, without compromising the ductility of the material since the small size of the particles does not create large concentrations of stresses,
an increase in the thermal conductivity and in various properties, in particular optical properties, which are not explained by the conventional thinking for the components. The nanoparticles, having dimensions smaller than the wavelengths of visible light (380-780 nm), enable the material to retain its initial optical properties and also a good surface finish,
an increase in electrical conductivity.

The reduction in the size of the reinforcements that are inserted into the matrix leads to a very large increase in the surface area of the interfaces in the composite. However, it is precisely this interface that controls the interaction between the matrix and the reinforcements, explaining some of the singular properties of the nanocomposites. It should be noted that the addition of nanoscale particles improves, significantly, certain properties with much smaller volume fractions than for micrometer-sized particles.

The following are thus obtained, at equal performance levels: a large weight gain and also a reduction in costs since fewer raw materials are used (without taking into account the additional cost of the nanoreinforcements), a better strength for similar structural dimensions and an increase in the barrier properties for a given thickness.

The remainder of the description relates more particularly to composites with a metal matrix and a carbon reinforcement as reinforcing element. For the purposes of the invention, the expression “carbon reinforcement” is understood to mean carbon nanotubes, carbon nanofibers and carbon fibers.

Powder metallurgy is a common process and gives very favorable results for the production of metal matrix composites. This process typically comprises a step of mixing the matrix in metal powder form with the reinforcement then a step of compaction and of densification treatment by diffusion and elimination of the voids (sintering). The manufacture of the composite is achieved by an extrusion step.

The drawback of this type of process is that it involves the manufacture of separate parts, and that it is not suitable for the manufacture of long products such as conductive wires for cables.

The present invention aims to solve these drawbacks.

The subject of the invention is thus a process for manufacturing a composite comprising a metal matrix reinforced by a carbon reinforcement.

The process according to the invention is a continuous extrusion process comprising the frictional heating of a mixture obtained from a mixture of powders comprising a metal matrix powder and a carbon reinforcement powder, using a movable extrusion wheel, between a groove of the wheel and a stationary element known as a shoe, then the conveying of the mixture thus heated to an extrusion die. The heating may in particular take place by compression of the mixture, friction then shearing on passing along the shoe.

This process is typically the “conform” process, that is known under the trade name CONFORM® by the company Holton Machinery Ltd., and which is described, for example, in document EP 0 125 788.

This process manufactures the composite by extrusion directly, and continuously, unlike conventional extrusion. The process consists in driving, by friction, a preform between a grooved wheel and a shoe. The metal is heated as it penetrates into the shoe. On coming to rest against the die, the composite mixture is at a temperature such that its extrusion through the die is possible. Finished products such as electrical conductors for cables and metal reinforcing elements are thus obtained directly.

The extruded composite may be an electrical conductor for a cable, a wire rod or a wire intended for a mechanical reinforcement.

The lower end of the passage may be obstructed by an abutment.

The entrance of the die is typically orthogonal to the lower end of the passage.

The mixture may come from a hopper. In this case, the mixture introduced into the hopper may be obtained by flocculation of the mixture of powders.

The mixture may also be obtained by pre-extrusion of the mixture of powders. The pre-extrusion may for example be carried out using a screw extruder.

The elements of the metal matrix may be selected from copper, aluminum, copper alloys and aluminum alloys.

The mixture of powders may comprise from 0.01% to 1.8% by weight of metal matrix when the metal matrix is copper or a copper alloy, and preferably from 0.05% to 0.2% by weight.

The mixture of powders may comprise from 0.03% to 6% by weight of metal matrix when the metal matrix is aluminum or an aluminum alloy, and preferably from 0.15% to 0.6% by weight.

The mixture of powders may consist of metal matrix powder and carbon reinforcement powder. It may also comprise adjuvants.

The mean size of the particles of metal matrix powder may be between 10 nm and 1 mm, and preferably between 10 and 200 nm.

The carbon reinforcement may consist of carbon nanotubes.

The mean diameter of the carbon nanotubes may be between 0.5 and 90 nm, and preferably between 1 and 40 nm.

The length of the carbon nanotubes may be between 500 nm and 10 mm, and is preferably greater than 50 μm, and may thus be between 50 μm and 10 mm.

Before the mixing thereof with the metal matrix, the carbon nanotubes are advantageously functionalized, in order to deagglomerate them and disperse them and to enable the best possible bonding with the metal matrix. Many functionalization treatments are known, from acid treatment for grafting radicals to the nanotubes, to treatment that aims to deposit a metal at the surface of the nanotubes.

The metal matrix and the carbon reinforcement are preferably sufficiently mixed to obtain a good dispersion, but not excessively so as not to break or damage the carbon reinforcement.

After the extrusion step, it is possible to envisage a heat treatment, so as to promote the reinforcement-matrix bonding.

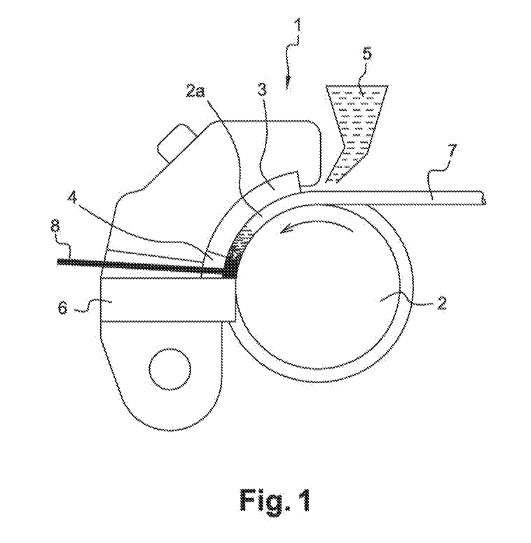

Other features and advantages of the present invention will become more clearly apparent on reading the following description given by way of illustrative and non-limiting example and with reference to the appended FIG. 1 that schematically illustrates a device used in the process according to the invention.

As illustrated in FIG. 1, a continuous extrusion device 1 used in the invention comprises a frame, an extrusion wheel 2 and a shaping system. The shaping system comprises mainly a shoe 3 and an extrusion die 4. The frame supports the wheel 2 which is rotated by a motor. An endless groove 2a is formed at the periphery of the wheel 2 and receives a mixture that may come from a hopper 5. The mixture is a mixture of a powder of metal, typically of copper or aluminum, and a powder of carbon reinforcement, typically of carbon nanotubes.

In a first embodiment, the mixture of powders may be introduced into the hopper 5. In this case, the mixture of powders is advantageously subjected to a flocculation step, which makes it possible to form larger particles and to make the powder more manipulable for the introduction thereof into the extruder.

In a second embodiment, it is possible to place, upstream of the device, a screw extruder that will form a preformed rod 7, with a low density, but that will be sufficiently manipulable to be introduced directly into the device. In this second embodiment, the hopper 5 is of course not used.

A portion of the periphery of the wheel 2 is closely enveloped by the shoe 3, so that the groove 2a cooperates with the shoe 3 in order to delimit a passage. The mixture of powders from the hopper 5, or the mixture in the form of a preformed rod 7, enters into a first end of the passage and is rotated by the wheel 2. The other end of the passage is obstructed by an abutment 6 which is mounted on the shoe 3 and which intrudes into the passage. As the mixture is confined in the passage and since the wheel 2 continues to turn, the mixture is heated by friction with the groove 2a. The die 4 is mounted in a chamber formed directly downstream of the abutment 6. The heat supplied to the mixture enables extrusion thereof through the die 4.

Thus, the process according to the invention enables the rapid and economical manufacture of long products 8, such as conductive wires for a cable. Moreover, the process imparts a preferential orientation to the carbon nanotubes, which are oriented in the axis of the wire, which gives a better electrical conductivity.

1. A process for manufacturing a composite including a metal matrix reinforced by a carbon reinforcement,
said process comprising the steps of:
a continuous extrusion process including the frictional heating of a mixture obtained from a mixture of powders having a metal matrix powder and a carbon reinforcement powder, using a movable extrusion wheel, in a passage formed between a groove of the wheel and a stationary element known as a shoe, then the conveying of the mixture thus heated to an extrusion die.

2. The process as claimed in claim 1, wherein the extruded composite is an electrical conductor for a cable, a wire rod or a wire intended for a mechanical reinforcement.

3. The process as claimed in claim 1, wherein the lower end of the passage is obstructed by an abutment (6).

4. The process as claimed in one of claims 1 to 3, wherein the entrance of the die is orthogonal to the lower end of the passage.

5. The process as claimed in claim 1, wherein the mixture comes from a hopper.

6. The process as claimed in claim 5, wherein the mixture introduced into the hopper is obtained by flocculation of the mixture of powders.

7. The process as claimed in claim 1, wherein the mixture is obtained by pre-extrusion of the mixture of powders.

8. The process as claimed in claim 7, wherein the pre-extrusion is carried out using a screw extruder.

9. The process as claimed in claim 1, wherein the elements of the metal matrix are selected from copper, aluminum, copper alloys and aluminum alloys.

10. The process as claimed in claim 9, wherein the mixture of powders comprises from 0.01% to 1.8% by weight of metal matrix when the metal matrix is copper or a copper alloy.

11. The process as claimed in claim 9, wherein the mixture of powders comprises from 0.03% to 6% by weight of metal matrix when the metal matrix is aluminum or an aluminum alloy.

12. The process as claimed in claim 1, wherein the mean size of the particles of metal matrix powder is between 10 nm and 1 mm.

13. The process as claimed in claim 1, wherein the carbon reinforcement is made of carbon nanotubes.

14. The process as claimed in claim 13, wherein the mean diameter of the carbon nanotubes is between 0.5 and 90 nm.

15. The process as claimed in claim 13, wherein the length of the carbon nanotubes is between 500 nm and 10 mm.
